(19) United States
(12) Patent Application Publication
(10) Pub. No.: US 2025/0347166 A1
(43) Pub. Date: Nov. 13, 2025

(54) METHOD AND APPARATUS FOR ADAPTING POWER ASSISTANCE PROVIDED BY DOOR OPERATOR

(71) Applicant: Schlage Lock Company LLC, Camel, IN (US)

(72) Inventor: John A. Wolfe, Cicero, IN (US)

(21) Appl. No.: 18/662,158

(22) Filed: May 13, 2024

(51) Int. Cl. E05F 15/75; E05F 15/63

(52) U.S. Cl. CPC E05F 15/75; E05F 15/63; E05Y 2400/3015; E05Y 2400/302; E05Y 2400/31; E05Y 2400/356; E05Y 2400/36

(57) ABSTRACT

A door is coupled to a door operator that includes a motor operable in a predefined power assist mode to open the door from the closed position toward the open position. The assistance provided by the motor is reduced relative to the assistance in the power assist mode in response to the door opening angle being more than a threshold amount, and further in response to a speed of the door exceeding a threshold amount as the door is being opened.

### FIELD OF THE INVENTION

The present disclosure generally relates to a door and a door operator, and more particularly to adapting a door operator configured to assist in opening the door.

### BACKGROUND

Door operators are configured to move a door from an open position to a closed position under control of a spring mechanism, a motor, a valve, or other actuators. Some door operators include a motor that is electrically powered to assist in opening the door. For example, some door operators are controlled so that when a user begins to push the door open, the door operator automatically assists the user in manually opening the door by acting against the spring that resists opening the door, making the door feel lighter to the user. These automatic door operators are typically set to open the door slowly to provide assistance to the elderly, children, or other users that might struggle with manually opening the door without assistance.

However, the assistance that is provided by the motor in opening the door may be unnecessary or too great for users that open the door quickly. As a result, the door may be opened at a speed that is greater than is desired or optimal. In addition, once the user stops pushing on the door, the assistance provided by the motor continues to offset the force of the spring, causing the door to travel further before it stops. For outside doors, wind may also cause the door to continue to travel faster than is desired to the open position. Thus, the door may travel too fast into the mechanical stops, and/or require braking by the motor. As a result, the door operator and door frame are subject to more wear and tear than is desired. There is a need, therefore, for further improvements in the operation and control of door operators that assist in manual door opening.

### SUMMARY

As described herein, a system and method is provided for a door with a motor-driven door operator that includes a motor that assists in manually opening the door while operating in a nominal or predefined power assist mode. The predefined power assist mode is overridden during opening of the door to adjust the assistance provided by the motor in opening the door. For example, during opening of the door, the assistance provided by the motor relative to the predefined power assist mode is reduced when the door is opened to exceed a threshold door angle. In addition or alternatively, the assistance provided by the motor is reduced relative to the predefined power assist mode in response to the speed of the door exceeding a threshold speed.

In one embodiment, there is provided a method for adjusting the opening of a door coupled to a door operator assembly having a motor that assists in opening the door. The door pivots during opening so that an angle of the door increases from the closed position toward the fully open position. The method includes operating the motor in a predefined power assist mode to open the door from a closed position toward a fully open position. During operating the motor, the method includes determining a speed of the door exceeds a threshold speed, or the angle of the door exceeds a threshold angle. In response to the determining, the method includes adjusting the motor from the predefined power assist mode to reduce assistance from the motor to the door during opening the door.

In another embodiment, there is provided a system for adjusting the opening of a door coupled to a door operator assembly having a motor and a controller configured to control the motor during movement of the door from a closed position to an open position in which the angle of the door increases. The controller is configured to operate the motor in a predefined power assist mode to open the door from the closed position toward the fully open position, determine that a speed of the door exceeds a threshold speed and/or the angle of the door exceeds a threshold angle, and reduce assistance from the motor to the door relative to assistance provided in the predefined power assist mode during opening the door in response to the speed of the door exceeding the threshold speed and/or the angle of the door exceeding a threshold angle.

Further embodiments, forms, features, and aspects of the present application shall become apparent from the description and figures provided herewith

### BRIEF DESCRIPTION OF THE DRAWINGS

FIG. 1 is a schematic elevation view of a door operator assembly coupled to a door and to a door frame.

FIG. 2 is a schematic view showing the door of FIG. 1 opening from a closed position to an open position.

FIG. 3 is a schematic block diagram of selected components of the door operator assembly and door illustrated in FIG. 1.

FIG. 4 is a graph showing assistance from the motor in opening the door relative to the door angle.

FIG. 5 is a graph showing reduction in assistance from the motor in opening the door relative to the door speed.

FIG. 6 is a block diagram of a process to open the door with the door operator assembly.

### DETAILED DESCRIPTION

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should further be appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described.

Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Items listed in the form of “A, B, and/or C” can also mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

In the drawings, some structural or method features may be shown in certain specific arrangements and/or orderings. However, it should be appreciated that such specific arrangements and/or orderings may not necessarily be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may be omitted or may be combined with other features.

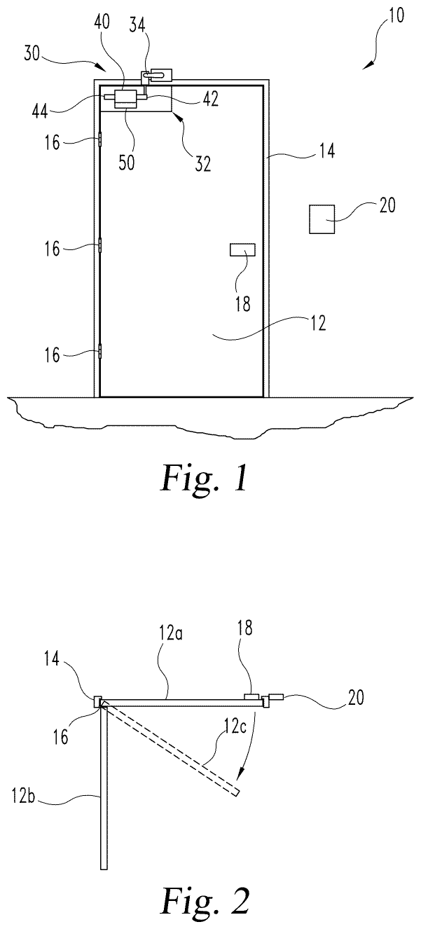

FIG. 1 illustrates a system 10 that includes a door 12, a frame 14, and a door operator assembly 30 operable to mechanically move door 12 from a closed position to an open position. In an embodiment, door 12 is pivotally mounted to frame 14 with one or more hinges 16. In an embodiment, door 12 includes an on-door actuator 18 operable to open door 12. On-door actuator 18 can be a lever, knob, pushbar, push pad, button, sensor or any other suitable device. However, embodiments without an on-door actuator 18 are also contemplated. In an embodiment, on-door actuator 18 is a sensor that sense when the user is in contact with door 12, and can provide an output signal while such contact is occurring.

In addition, embodiments with an off-door actuator 20 that is remote from door 12 are also contemplated, such as may be employed in handicap or disabled person access devices. Off-door actuator 20 may be a push button, mat plate, infrared device, sensor, or other device that is manually moved or senses a user's approach to initiate automatic door opening. In an embodiment, off-door actuator 20 is a mat, camera, infrared device, etc. that senses when the user is in contact with door 12, and can provide an output signal while such contact is occurring. In an embodiment, on-door actuator 18 and off-door actuator 20 work together to function as a touch sensor to indicate the user in in contact with or engaged to door 12.

Door operator assembly 30 includes an operator housing 32 and an arm assembly 34 connected between the operator housing 32 and the frame 14. The housing 32 is mounted on the door 12, and the arm assembly 34 is connected between the body 32 and the door frame 14. In other embodiments, the housing 32 may be mounted on the frame 14, and the arm assembly 34 may be connected between the housing 32 and the door 12.

Door operator assembly 30 further includes a motor 40 positioned within housing 32. Motor 40 is operably connected to arm assembly 34. In an embodiment, motor 40 is an electric motor whose operation is controlled by a controller 50 positioned in housing 32. Referring further to FIG. 2, motor 40 is operable in response to one or more inputs to move door 12 in the direction A about hinges 16 from the closed position 12a to the open position 12b. The one or more inputs can be received from, for example, on-door actuator or sensor 18, off-door actuator or sensor 20, and/or by a user manually pushing on door 12 in the direction A.

Operator housing 32 can include an interior space configured to house all or a part of various internal components of the door operator assembly 30, such as motor 40, a drive mechanism 42, a biasing member 44, and/or controller 50. Drive mechanism 42 can connect motor 40 to arm assembly 34. For example, drive mechanism 42 can include a rotatable pinion and a rack drivingly engaged with the pinion. Other embodiments contemplate any suitable mechanism for driving door 12 to an open position using motor 40.

The biasing member 44 can be a spring or other bias element engaged with the drive mechanism 42 to bias door 12 to a closed position. In an embodiment, biasing member 44 provides resistance to opening of door 12 that is overcome by motor 40 and/or manual force. In an embodiment, the resistance provided by biasing member increases as door 12 is moved in the direction A.

The arm assembly 34 generally includes at least one arm coupled to drive mechanism 42 and a second arm coupled between the first arm and the door 12 or frame 14. In an embodiment, arm assembly 34 is configured as a scissors-type arm assembly. It is also contemplated that the arm assembly may include a single arm, with one end coupled to motor 40 and a second end slidably mounted in a track mounted on the door 12 or the door frame 14. Other embodiments contemplate any suitable arm assembly, actuator, opener, or other arrangement connected between door 12 and frame 14 that is configured to open door 12 about hinges 16.

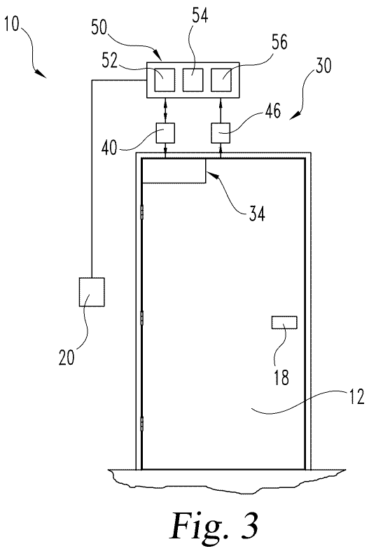

Referring to FIG. 3, the controller 50 is in communication with the motor 40, and may further be in communication with an input mechanism, such as on-door actuator or sensor 18, or off-door door actuator or sensor 20. As illustrated, the controller 50 includes a processor 52, an actuation unit 54, and a memory 56. As described in further detail below, the actuation unit 54 is configured to activate the motor 40 and/or to receive inputs from motor 40, drive mechanism 42, and/or a sensor 46 to evaluate one or more parameters associated with opening door 12.

The memory 56 is a non-transitory computer readable medium having data stored thereon, and is in communication with the processor 52. The data stored on the memory 56 may include, for example, one or more sets of instructions, one or more look-up tables, and/or additional data. The instructions may be executed by the processor 52 to cause the processor 52 to perform one or more functions such as, for example, the function of opening door 12 with actuation unit 54. While the controller 50 may be housed within the operator housing 32, it is also contemplated that the controller 50 may be positioned elsewhere on the door operator assembly 30 or externally to the door operator assembly 30.

The processor 52, in different embodiments, is a programmable type, a dedicated, hardwired state machine, or a combination of these, and can further include multiple processors, Arithmetic-Logic Units (ALUs), Central Processing Units (CPUs), Digital Signal Processors (DSPs) or the like. Other forms of processor 52 include multiple processing units, distributed, pipelined, and/or parallel processing. The processor 52 may be dedicated to performance of the operations described herein or may be utilized in one or more additional applications. In the depicted form, the processor 52 is of a programmable variety that executes algorithms and processes data in accordance with defined by programmed instructions (such as software or firmware) stored in memory 56. Alternatively or additionally, the operating logic for processor 52 is at least partially defined by hardwired logic or other hardware. The processor 52, in different embodiments, is comprised of one or more components of any type suitable to process the signals received from input/output devices, and provide desired output signals. Such components may include digital circuitry, analog circuitry, or a combination of both.

The memory 56 includes one or more types, such as a solid-state variety, electromagnetic variety, optical variety, or a combination of these forms. Furthermore, the memory 56 includes, in different embodiments, volatile, nonvolatile, or a combination of these types, and a portable variety, such as a disk, tape, memory stick, cartridge, or the like. In addition, the memory 56 is configured to store data that is manipulated by the operating logic of the processor 52, such as data representative of signals received from and/or sent to the door operator in addition to or in lieu of stored program instructions, just to name one example.

The actuation unit 54 is configured to operate in a nominal or predefined power assist mode of operation in response to one or commands from processor 52. In the power assist mode, the output of motor 40 is regulated by actuation unit 54 to control the opening the door 12 in a predefined manner to provide a predetermined level or amount of assistance in opening door 12. In some embodiments, the amount of assistance in the predefined power assist mode is fixed and pre-programmed by the manufacturer. In some embodiments, the installer or owner of the door may select the amount of power assistance that is provided in the predefined power assist mode by manipulating a value or setting on controller 40. For example, a value ranging from minimum assistance 1 to maximum assistance 10 may be selected.

In an embodiment the predefined power assist mode applies a constant torque assist in opening door 12 so that that a fixed amount of dooring opening resistance is removed from the opening force supplied by the user. As a result, the amount of force from the user to open the door is reduced by a fixed amount at all door angles from the closed position 12a to the closed position 12b.

In another embodiment, the predefined power assist mode controls the output of motor 40 so that motor 40 drives the door 12 at a torque that varies depending on the angle of opening of the door 12. In this embodiment, the force applied by a user to open the door from the closed position to the fully open position can be constant since the motor 40 adapts for the varying resistance to opening of door 12 as it moved from the closed position 12a to the open position 12b due to friction, kinematics of arm assembly 34, and/or biasing member 44.

As will be appreciated by the description herein, the techniques described herein relating to door opening control can be implemented in controller 50, which may include one or more controllers for controlling different aspects of the system 10. In one form, the controller 50 comprises one or more electronic control units or electronic control modules. In addition, any other suitable sensors and their associated parameters may be encompassed by the system and methods disclosed herein. Accordingly, the sensors may include any suitable device used to sense any relevant physical parameters including electrical and mechanical parameters of system 10. As used herein, the term sensors may include any suitable hardware and/or software used to sense or estimate any door system parameter and/or various combinations of such parameters either directly or indirectly.

As shown in FIG. 2, the door 12 moves in the direction A from the closed position 12a to one or more intermediate positions 12c, then to the open position 12b. As used herein, the angle of door 12 is 0 degrees at closed position 12, and 90 degrees at open position 12b. The door 12 has a range of positions between closed position 12a and open position 12b. As will be appreciated, the arm assembly 134 has a plurality of arm positions each of which correspond to one of the door positions. The force required from motor 40 to open the door may vary along the path of travel depending on the angular position of the door 12 between the closed and open positions, the kinematics of arm assembly 134 in those positions, the resistance provided by biasing member 44, and other factors such as friction, wind, etc.

In an embodiment, intermediate position 12c is a threshold door angle to which healthy users typically quickly push door 12 to enter before either slowing pushing on the door 12, or terminating pushing on door 12. In a specific embodiment, the threshold door angle is or is about 70 degrees. Other threshold angles are also contemplated, depending on the design and configuration of door 12 and door operator assembly 30.

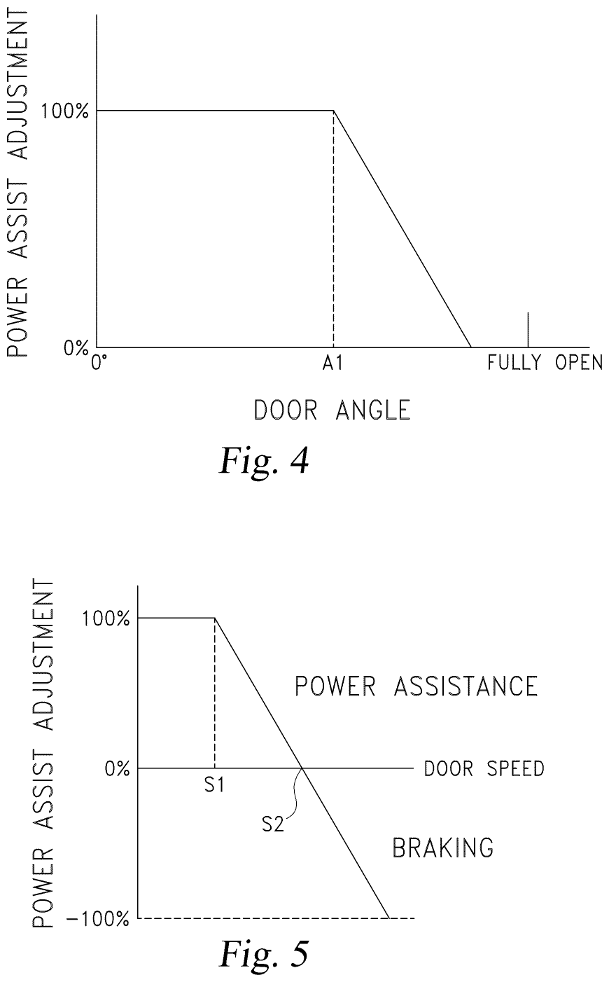

Referring to FIG. 4, controller 50 is configured to reduce the assistance provided by motor 40 relative to the assistance provided while operating under the predefined power assist mode once the opening angle of door 12 reaches or exceeds the threshold angle A1. In an embodiment, the assistance provided by motor 12 is progressively decreased as the door angle increases above the threshold angle toward the open position 12b. In an embodiment, the assistance from motor 40 is terminated before door 12 reaches open position 12b, such as between 90% and 100%.

Referring to FIG. 5, controller 50 is configured to reduce the assistance provided by motor 40 relative to the assistance provided while operating under the predefined power assist mode once the opening speed of door 12 reaches or exceeds the threshold speed S1. In an embodiment, the assistance provided by motor 12 is progressively decreased as the door speed increases above the threshold angle toward the open position 12b. In an embodiment, the assistance from motor 40 is negative in order to provide braking before door 12 reaches open position 12b if the door speed exceeds a second speed threshold S2.

The angle and/or speed of door 12 can be measured with one or more sensors 46. Sensors 46 may include, for example, a position sensor (angular, rotary, linear, etc.) to provide an output indicative of the door angle. The one or more sensors 46 may also or alternatively include a speed sensor (Hall effect, accelerometer, gear tooth, magnetic, optical, angular, etc.) to provide an output to controller 50 indicative of door speed. Door speed may also or alternatively be determined by monitoring the current that flows through the motor 40 during opening since current is directly proportional to the back electromotive force (BEMF) of the motor.

While the user pushes door 12 with a force or speed that is less than the speed threshold S1 and/or the door angle is less than the threshold angle A1, motor 40 is controlled in the predefined power assist mode to provide 100% of the programmed power assistance using motor 40. If the user then begins to push the door 12 slightly faster than the threshold speed S1, the controller 50 will override the power assist mode of control of motor 40 so that the assistance provided is automatically reduced relatively to the assistance provided under the predefined power assist mode. As the user continues to push door 12 increasingly faster, the user takes on a greater amount of the overall opening force needed to open the door 12, and the motor 40 is controlled to progressively take on less assistance in opening door 12. Once the door speed reaches a predefined second speed threshold S2 during opening of door 12, the controller 50 further reduce the assistance provided by motor 40 in order to operate in a braking mode. Opening of the door at increasing speed above second speed threshold S2 will result in increasing braking force being applied via motor 40.

Additionally or alternatively, once the door angle exceeds threshold angle A1, the door the controller 50 will control motor 40 so that the assistance provided is reduced from the assistance provided under the predefined power assist mode. As the user continues to push door 12 increasingly further open, the assistance from motor 40 is progressively reduced until assistance is terminated at or before door 12 reaches open position 12b.

This dynamic adjustment of the power assist mode to reduce the assistance from motor 40 during operation includes dynamically adjusting the assistance provided relative to the predefined power assist mode to provide progressively reduced assistance from the motor for door speed exceeding a speed threshold S1 and/or the door opening exceeding a threshold angle A1. The dynamic adjustment in the power assist mode can account for the increasing opposing force of the biasing member 44 as it resists opening of the door 12, such as by compression of a spring. In addition, the dynamic adjustment in the power assist mode can account for the kinematics and leverages of the arm assembly 34 during opening. Additionally, as the door speed further increases, the back electromagnetic fields of the motor 40 increase, and the dynamic adjustment of the power assist mode during opening of door 12 can account for the increasing voltage that must be applied to the motor 40 in order to maintain a targeted force or motor current for assistance in opening door 12.

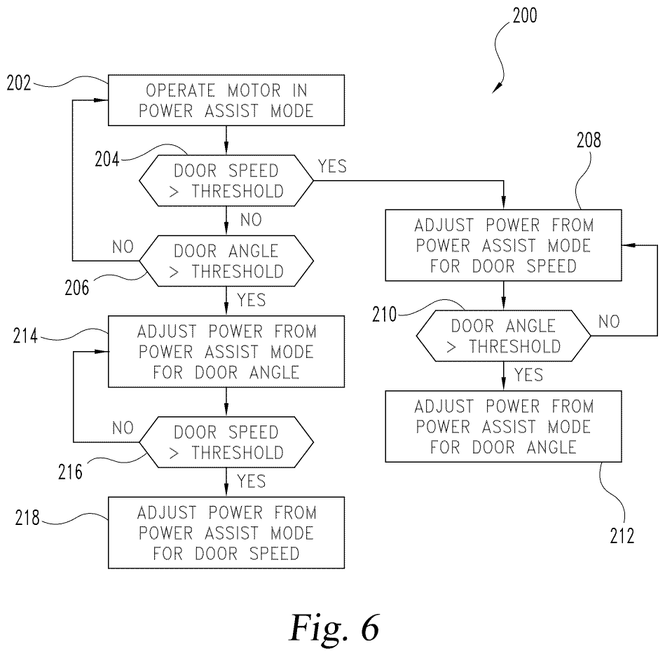

With reference to FIG. 6, there is illustrated a flow diagram of a process 200 for controlling the opening of door 12 with controller 50. Process 200 may be implemented in and performed by one or more components of an electronic control system such as one or more electronic control units (e.g., controller 50 and/or other electronic control units) and/or by other electronic control system components.

Process 200 begins at operation 202 in which motor 40 is operated in a predefined power assist mode to open door 12. In the predefined power assist mode, the motor 40 is operated to provide a nominal or predefined power assistance in opening door 12 from the closed position toward, or to, the open position. In FIGS. 4 and 5, the motor 40 is initially controlled entirely (i.e. at 100% of the power assist mode) based on this nominal or predefined power assistance as the opening of door 12 is initiated.

Process 200 continues at conditional 204, which determines if door 12 is opening at a speed greater than the threshold speed S1. The door opening speed may, for example, be determined in response to output from one or more sensors 46, or one or more parameters (current, voltage, etc.) of motor 40. If conditional 204 is NO, process 200 continues at conditional 206 to determine if the door angle is greater than the threshold angle A1. The door angle may be determined, for example, in response to output from one or more sensors 46. If conditional 206 is NO, process 200 returns to operation 202.

If conditional 204 is YES, the process 200 continues at operation 208 to provide an adjustment of the motor from the predefined power assist mode controlling the output from motor 40. For example, as shown in FIG. 5, the amount of power assist adjustment progressively reduces the assistance provided by motor 40 relative to the power assistance provided in the predefined power assist mode from 100% so that the output from motor 40 to the door 12 is decreased as the speed of door 12 increases above speed threshold S1. Motor 40 can even be employed as a brake at door speeds above speed threshold S2.

Process 200 continues from operation 208 at conditional 210 to determine if the door angle is greater than the threshold angle A1. If conditional 210 is NO, process 200 returns to operation 208. If conditional 210 is YES, process 200 continues at operation 212 to provide an adjustment of the motor from the predefined power assist mode controlling the output from motor 40. For example, as shown in FIG. 4, the power assist adjustment progressively reduces the assistance provided by motor 40 relative to the assistance provided under the predefined power assist mode from 100%, or from an already adjusted assistance level, so that the output from motor 40 to the door 12 is further decreased as the door angle increases above threshold angle A1.

Similarly, if conditional 206 is YES, process 200 continues at operation 214 to provide an adjustment of the motor from the predefined power assist mode controlling the output from motor 40 based on the door angle. Process 200 continues from operation 214 at conditional 216 to determine if the door speed is greater than the threshold speed S1 while the door angle is greater than the threshold angle A1. If conditional 216 is NO, process 200 returns to operation 214 until door 12 comes to a stop. If conditional 216 is YES, the process 200 continues at operation 218 to provide a further adjustment of the motor from the predefined power assist mode so that the assistance from motor 40 to the door 12 is further decreased as the speed of door 12 increases above speed threshold S1 while the door angle is greater than threshold angle A1. Motor 40 can even be employed as a brake at operation 218 at door speeds above speed threshold S2, such as might occur when door 12 is forced toward the open position 12b by wind.

In an embodiment, controller 50 is configured to perform process 200. In an embodiment, controller 50 is configured to control the motor 40 to assist to open the door 12 based on a predefined power assist mode, and the motor 40 is modified or adjusted relative to the predefined power assist mode in response to the speed of the door exceeding a threshold speed and/or an angle of the door exceeding a threshold angle. Assistance from motor 40 is reduced or eliminated during opening of door 12 relative to the assistance provided by motor 40 with the predefine power assist mode in order to slow the door opening and reduce or eliminate undesirable stopping forces against the mechanical stops in operator assembly 30 or arm assembly 34, against a wall or obstruction, and/or in braking of door 12 at the full open position.

In an embodiment, controller 50 is configured to initiate operation in the predefined power assist mode in response to the user engaging or touching the door based on an input from touch sensor 18 and/or detection of manual movement of the door 12. Controller 50 can terminate operating the motor 40 in the predefined power assist mode in response to the touch sensor 18 indicating a user is not in contact with the door 12. As long as the user is engaged with the door 12 and/or door 12 is moving toward the open position, the predefined power assist mode of operation is engaged to lighten the door. As soon as the user becomes disengaged with the door and/or movement of the door is stopped or slowed to indicate the user is no longer pushing the door, the controller 50 can stop the power assist mode of operation and allow the full force of the biasing member 44 to bring the door 12 to an eventual stop and/or start to close the door 12.

Various aspects of the present disclosure are contemplated. According to one aspect, a method for opening a door coupled to a door operator assembly having a motor is provided. The method includes operating the motor in a predefined power assist mode to open the door from a closed position toward a fully open position, where the door pivots during opening so that an angle of the door increases from the closed position toward the fully open position; during operating the motor, determining: a speed of the door exceeds a threshold speed or the angle of the door exceeds a threshold angle; and in response to the determining, adjusting the motor from the predefined power assist mode to reduce assistance from the motor to the door during opening the door.

In an embodiment, the predefined power assist mode drives the motor at a fixed torque to open the door from the closed position to the fully open position.

In an embodiment, the predefined power assist mode drives the door with the motor at a torque that varies depending on the angle of the door so that a force applied by a user to open the door from the closed position to the fully open position is constant.

In an embodiment, during operating the motor, the method includes determining the angle of the door exceeds the threshold angle and then progressively reducing assistance provided by the motor relative to the assistance provided in the predefined power assist mode as the angle of the door increases from the threshold angle toward the fully open position.

In an embodiment, during operating the motor, the method includes determining the speed of the door exceeds the threshold speed and then progressively reducing the assistance provided by the motor relative to the assistance provided in the predefined power assist mode as the speed of the door increases above the threshold speed.

In an embodiment, the angle of the door is 0 degrees in the closed position and 90 degrees in the fully open position, and the threshold angle is 70 degrees. In a further embodiment, the power provided by the motor is reduced to zero before the angle of the door is 90 degrees.

In an embodiment, during operating the motor, the method includes determining the speed of the door exceeds the threshold speed and then progressively reducing the assistance provided by the motor relative to the assistance provided in the predefined power assist mode as the speed of the door increases above the threshold. In a further embodiment, the method includes braking the door with the motor.

In an embodiment, the method includes terminating operating the motor in the predefined power assist mode in response to a user not contacting the door.

According to another aspect of the disclosure, a system for opening a door mounted to a frame is provided. The system includes a door operator connectable between the door and the frame, where the door pivots during opening so that an angle of the door increases from a closed position toward a fully open position. The system includes a motor operable to drive the door operator to move the door from the closed position to the open position, and a controller connected to the motor. The controller is configured to operate the motor in a predefined power assist mode to open the door from the closed position toward the fully open position, determine that a speed of the door exceeds a threshold speed and/or the angle of the door exceeds a threshold angle, and reduce assistance from the motor to the door relative to assistance provided in the predefined power assist mode during opening the door in response to the speed of the door exceeding the threshold speed and/or the angle of the door exceeding a threshold angle.

In an embodiment, the door operator includes a biasing member configured to increasingly resist movement of the door toward the open position.

In an embodiment, the door operator includes an arm assembly connectable to at least one of the door and the frame, and a drive mechanism that connects the motor to the arm assembly.

In an embodiment, in the predefined power assist mode the controller is configured to drive the motor at a fixed torque to open the door from the closed position to the fully open position.

In an embodiment, in the predefined power assist mode the controller is configured to drive the door with the motor at a torque that varies depending on the angle of the door so that a force applied by a user to open the door from the closed position to the fully open position is constant.

In an embodiment, controller is configured to progressively reduce the assistance provided by the motor relative to the assistance relative to the assistance provided in the predefined power assist mode as the angle of the door increases from the threshold angle toward the fully open position. In a further embodiment, the angle of the door is 0 degrees in the closed position and 90 degrees in the fully open position, the threshold angle is 70 degrees, and the controller is configured to terminate operation of the motor before the angle of the door is 90 degrees.

In an embodiment, the controller is configured to progressively reduce the assistance provided by the motor relative to the assistance provided in the power assist mode as the speed of the door increases above the threshold speed. In a further embodiment, the controller is configured to brake the door with the motor in response to a speed of the door exceeding a second threshold speed.

In an embodiment, the controller is configured to terminate operating the motor in the predefined power assist mode in response to a touch sensor indicating a user is not in contact with the door, a decrease in door speed indicating a user has stopped pushing, and/or the door comes to a stop.

It shall be appreciated that terms such as “a non-transitory memory,” “a non-transitory memory medium,” and “a non-transitory memory device” refer to a number of types of devices and storage mediums which may be configured to store information, such as data or instructions, readable or executable by a processor or other components of a computer system and that such terms include and encompass a single or unitary device or medium storing such information, multiple devices or media across or among which respective portions of such information are stored, and multiple devices or media across or among which multiple copies of such information are stored.

It shall be appreciated that terms such as “determine,” “determined,” “determining” and the like when utilized in connection with a control method or process, an electronic control system or controller, electronic controls, or components or operations of the foregoing refer inclusively to a number of acts, configurations, devices, operations, and techniques including, without limitation, calculation or computation of a parameter or value, obtaining a parameter or value from a lookup table or using a lookup operation, receiving parameters or values from a datalink or network communication, receiving an electronic signal (e.g., a voltage, frequency, current, or pulse-width modulation (PWM) signal) indicative of the parameter or value, receiving output of a sensor indicative of the parameter or value, receiving other outputs or inputs indicative of the parameter or value, reading the parameter or value from a memory location on a computer-readable medium, receiving the parameter or value as a run-time parameter, and/or by receiving a parameter or value by which the interpreted parameter can be calculated, and/or by referencing a default value that is interpreted to be the parameter value.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected.

It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A method for opening a door coupled to a door operator assembly having a motor, the method comprising:
operating the motor in a predefined power assist mode to open the door from a closed position toward a fully open position, wherein the door pivots during opening so that an angle of the door increases from the closed position toward the fully open position;
during operating the motor, determining:
a speed of the door exceeds a threshold speed; or
the angle of the door exceeds a threshold angle; and
in response to the determining, adjusting the motor from the predefined power assist mode to reduce assistance from the motor to the door during opening the door.

2. The method of claim 1, wherein the predefined power assist mode drives the motor at a fixed torque to assist in manually opening the door from the closed position towards fully open position.

3. The method of claim 1, wherein the predefined power assist mode drives the door with the motor at a torque that varies depending on the angle of the door so that a force applied by a user to open the door from the closed position towards the fully open position is constant.

4. The method of claim 1, wherein during operating the motor, determining the angle of the door exceeds the threshold angle and then progressively reducing assistance provided by the motor relative to the assistance provided in the predefined power assist mode as the angle of the door increases from the threshold angle toward the fully open position.

5. The method of claim 4, wherein during operating the motor, determining the speed of the door exceeds the threshold speed and then progressively reducing the assistance provided by the motor relative to the assistance provided in the predefined power assist mode as the speed of the door increases above the threshold speed.

6. The method of claim 4, wherein the angle of the door is 0 degrees in the closed position and 90 degrees in the fully open position, and the threshold angle is 70 degrees.

7. The method of claim 6, wherein the power provided by the motor is reduced to zero before the angle of the door is 90 degrees.

8. The method of claim 1, wherein during operating the motor, determining the speed of the door exceeds the threshold speed and then progressively reducing the assistance provided by the motor relative to the assistance provided in the predefined power assist mode as the speed of the door increases above the threshold.

9. The method of claim 8, further comprising braking the door with the motor.

10. The method of claim 1, further comprising terminating operating the motor in the predefined power assist mode in response to a user not contacting the door.

11. A system for opening a door mounted to a frame, the system comprising:
a door operator connectable between the door and the frame, wherein the door pivots during opening so that an angle of the door increases from a closed position toward a fully open position;
a motor operable to drive the door operator to move the door from the closed position to the open position; and
a controller connected to the motor, wherein the controller is configured to:
operate the motor in a predefined power assist mode to open the door from the closed position toward the fully open position;
determine that a speed of the door exceeds a threshold speed and/or the angle of the door exceeds a threshold angle; and
reduce assistance from the motor to the door relative to assistance provided in the predefined power assist mode during opening the door in response to the speed of the door exceeding the threshold speed and/or the angle of the door exceeding a threshold angle.

12. The system of claim 11, wherein the door operator includes a biasing member configured to increasingly resist movement of the door toward the open position.

13. The system of claim 11, wherein the door operator includes:
an arm assembly connectable to at least one of the door and the frame; and
a drive mechanism that connects the motor to the arm assembly.

14. The system of claim 11, wherein in the predefined power assist mode the controller is configured to drive the motor at a fixed torque to assist to open the door from the closed position towards the fully open position.

15. The system of claim 11, wherein in the predefined power assist mode the controller is configured to drive the door with the motor at a torque that varies depending on the angle of the door so that a force applied by a user to open the door from the closed position to the fully open position is constant.

16. The system of claim 11, wherein the controller is configured to progressively reduce the assistance provided by the motor relative to the assistance relative to the assistance provided in the predefined power assist mode as the angle of the door increases from the threshold angle toward the fully open position.

17. The system of claim 16, wherein the angle of the door is 0 degrees in the closed position and 90 degrees in the fully open position, the threshold angle is 70 degrees, and the controller is configured to terminate operation of the motor before the angle of the door is 90 degrees.

18. The system of claim 11, wherein the controller is configured to progressively reduce the assistance provided by the motor relative to the assistance provided in the power assist mode as the speed of the door increases above the threshold speed.

19. The system of claim 18, wherein the controller is configured to brake the door with the motor in response to a speed of the door exceeding a second threshold speed.

20. The system of claim 11, wherein the controller is configured to terminate operating the motor in the predefined power assist mode in response to a touch sensor indicating a user is not in contact with the door, a decrease in door speed indicating a user has stopped pushing, and/or the door comes to a stop.
